(19) United States
(12) Patent Application Publication
(10) Pub. No.: US 2003/0049538 A1
(43) Pub. Date: Mar. 13, 2003

(54) Electrochemical energy storage device

(76) Inventors: Wolfgang Buerger, Hockessin, DE (US); Rudolf Steffl, Oy-Mittelberg (DE)

Correspondence Address: Allan M. Wheatcraft, W.L. Gore & Associates, Inc., 551 Paper Mill Road, P.O. Box 9206, Newark, DE, 19714-9206, US

(21) Appl. No.: 09/921,286

(22) Filed: Aug. 2, 2001

(51) Int. Cl. H01M 2/16; H01M 2/18; H01G 9/035

(52) U.S. Cl. 429/249; 429/206; 429/142; 429/46; 361/504

(57) ABSTRACT

An electrochemical energy storage device with at least two electrodes and an electrolyte, a carrier material for the electrolyte being disposed between the electrodes, and the carrier material including a porous material in whose inner pore structure a perfluoropolyether and/or fluorinated substance is present.

### FIELD OF THE INVENTION

This invention relates to an electrochemical energy storage device, and more particularly to a carrier material for use in an electrochemical energy storage device.

### BACKGROUND OF THE INVENTION

As used herein, electrochemical energy storage devices are devices capable of storing and releasing electrical energy, such as capacitors, supercapacitors, accumulators, batteries, and fuel cells.

There is a range of desirable properties needed for suitable performance of electrochemical energy storage devices. These properties include high capacitance, small size, efficient manufacturability and mechanical and electrical durability. An electrochemical energy storage device that improves all of these characteristics is desirable.

The use of expanded polytetrafluoroethylene (ePTFE) as a carrier material for an electrolyte disposed as a separator between two electrodes in an electrochemical energy storage device is known. The ePTFE is highly porous and has excellent chemical and thermal stability. This permits the thickness of the carrier material in the inventive electrochemical energy storage device to be kept small and thus the distance between the electrodes to be reduced. A small distance between the electrodes is desirable, in particular with capacitors, since this increases the energy density of the capacitor.

At the same time, however, the carrier material must permit reception of a sufficient quantity of electrolyte in order to allow good ion flow and ion mobility in the electrolyte between the electrodes. This can be ideally fulfilled using ePTFE by reason of the high porosity with which an ePTFE layer can be produced.

Additionally, the use of ePTFE allows production of a carrier material layer with very constant small thickness and uniform structure. Due to these properties the ePTFE carrier material can also serve as a reliable spacer between the electrodes. Furthermore, a uniform ion flow (movement) through the pore structure is ensured, and disturbances due to irregularities in the carrier material are excluded. The use of ePTFE as a porous fluoropolymer also ensures high flexibility.

In addition, in applications like Zn/Air and alkaline fuel cells, the separators are in contact with catalysts, exposed to heat, and exposed to strong electrolytes. ePTFE is particularly suitable for such an environment because it is resistant to these agents..

In electrochemical energy storage devices having very aggressive environments, such as batteries like nickel/cadmium high rate, nickel metal hybrid, rechargeable MnO₂, Zn—MnO₂, Zn/Air, alkaline capacitors and alkaline fuel cells, the pores of an ePTFE separator layer are filled with an electrolyte, such as aqueous alkaline electrolyte (e.g., KOH). By itself, ePTFE is not wettable by aqueous KOH solution like other microporous separators such as polypropylene (PP), polyethylene (PE), PVC, cellophane, nylon, or other materials. These ePTFE materials if used have to have enhanced hydrophilicities generated by radiation grafting, surfactant/polyelectrolyte coating or plasma/corona treatment.

Coating ePTFE separators or carrier materials with a surface modifying substance is known. Such substances include perfluoroalkylated surfactants and other known hydrocarbons or fluorosurfactants as described, for example, in EP Application No. 98947543.9. Such substances may modify the surface of the ePTFE to allow the carrier material to be penetrated or “wetted” by the electrolyte. Particularly in the harsh environments in the applications described above, however, such known substances are not suitable. In particular, it has heretofore been difficult to find a wetting agent that is compatible with KOH. Known hydrocarbons or fluorosurfactants are soluble in water or aqueous electrolyte solutions. Poisoning of the cathode or adsorption of the wetting agent onto catalytic sides may occur, which would reduce cathode and overall cell performance.

In addition, because of environmental concerns, perfluoroalkylated surfactants (a known wetting agent) will not be used in the future. Phase-out of these materials was announced by 3M, a major supplier, in May 2000. EPA regulations in the U.S. and environmental regulations in Europe also will not allow the use of straight chain fluorosurfactants made by electrochemical fluorination in the future.

A carrier material that is wettable by an electrolyte such as KOH and that has enhanced durability even under harsh conditions and that also improves other desirable properties of an electrochemical energy storage device is needed.

### SUMMARY OF THE INVENTION

The present invention is an electrochemical energy storage device with at least two electrodes and an electrolyte, a carrier material for the electrolyte being disposed between the electrodes, and the carrier material including a porous material with an inner pore structure coated with a perfluorinated polyether phosphate. The porous material is preferably a porous fluoropolymer, and more preferably ePTFE. It may also be a PTFE copolymer. Using polar perfluoropolyether with terminated phosphoric endgroups as the perfluorinated polyether phosphate, the inventors surprisingly found that this coating provides KOH wettability for ePTFE membranes as well as high thermal and chemical stability for performance under harsh conditions. The coating is a thin node and fibril coating that will not drastically change porosity and produces an extraordinarily low membrane resistance. The inner pore structure of the porous material is preferably coated at least partly with the perfluorinated polyether phosphate. The electrolyte is preferably KOH. The carrier material is alternatively a composite containing nano-scale ceramic, or a composite including thermoplastics. The porous material preferably has a porosity of greater than 50%, and more preferably greater than 70%.

### BRIEF DESCRIPTION OF THE DRAWING

FIG. 1 is a cross-sectional view of an electrochemical energy storage device according to an exemplary embodiment of the present invention.

FIG. 2A and 2B are scanning electron micrographs of a carrier material according to an exemplary embodiment of this invention.

### DETAILED DESCRIPTION OF THE INVENTION

The present invention provides a storage device which has a high capacity despite a low space requirement, is simple and cost-effective to produce, reliable in handling and characterized by long life. Specifically, an electrochemical energy storage device has been provided that has a durable electrochemical carrier material that is satisfactorily wettable by an electrolyte and has the desirable range of operating conditions.

The invention involves coating a porous material with a substance which modifies the surface properties of the porous material. If the substance shows solubility in the electrolyte, it may also favorably change the surface tension and ionic conductivity of the electrolyte.

The coating according to this invention is a perfluorinated polyether phosphate on the inner pore structure of the porous material. The perfluorinated polyether phosphate is suitable both for improving the surface properties of the material and for influencing the properties of the electrolyte. The porous material can thus be wetted by the electrolyte and receive and hold it reliably. This ensures excellent electrolytic transport, outstanding ion mobility, and low membrane resistance. This transport and mobility is of considerable importance for the ion flow in the electrolyte. The perfluorinated polyether phosphate is uniquely adapted to be compatible with ePTFE and with KOH, thereby allowing coating of the nodes and fibrils of the ePTFE and promoting wicking or wetting of the KOH into the void spaces or pores of the ePTFE defined by the nodes and fibrils.

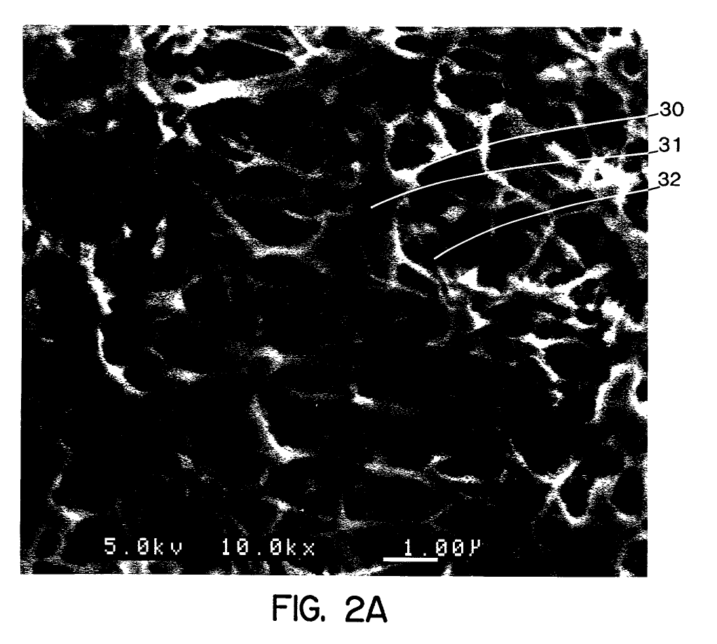

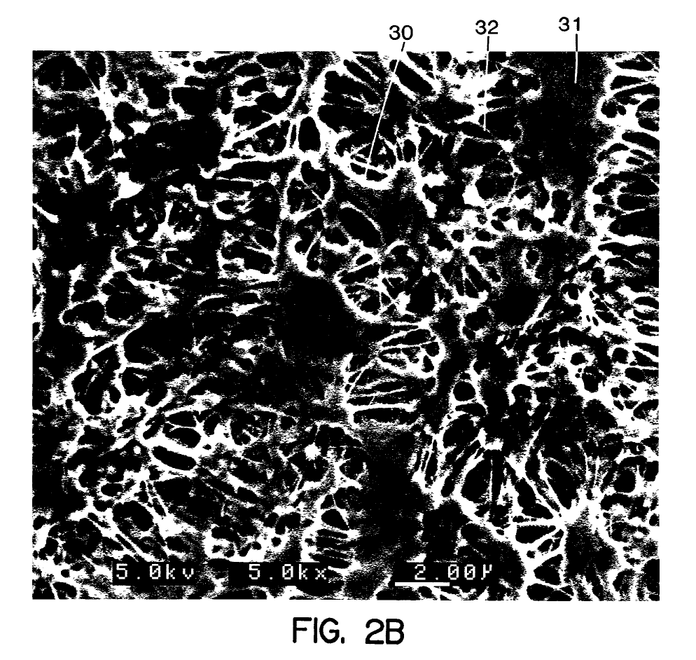

FIG. 2A shows an SEM of an exemplary embodiment of the present invention. An ultra-thin coating 30 of perfluorinated polyether phosphate is present over the nodes 31 and fibrils 32 of an ePTFE carrier material. FIG. 2B is an SEM of the same example at a different magnification. These SEMs show that coating the nodes and fibrils of ePTFE with perfluorinated polyether phosphate maintains the high porosity of the microporous membrane providing a large electrolyte reservoir after coating. Consequently the inventive storage device has outstanding capacity.

The porous material is preferably a porous fluoropolymer. Use of a porous fluoropolymer involves the advantage of providing a material with high chemical and thermal stability. Temperature resistance must be ensured since high temperatures can be present in the energy storage device, e.g. upon charging and discharging at high current densities and melting of the carrier material must be avoided. The carrier material is additionally exposed to the electrolyte and/or redox systems in the storage device. The electrolyte is normally a chemically active substance, e.g. a strong acid or base. The carrier material must therefore have sufficient chemical stability.

The porous material used in the inventive energy storage device is preferably PTFE. This material has excellent chemical and thermal stability and can be produced with high porosity.

One can further use PTFE copolymers or blends of PTFE homopolymers as the porous material.

According to a further embodiment the carrier material can be a composite containing nano-scale ceramic. The presence of this, e.g. ion-conductive, ceramic makes the carrier material take part in the ion flow in the electrolyte. This increases the total ionic conductivity and improves the efficiency of the energy storage device at a given porosity. The nano-scale ceramic is preferably present in a quantity of no more than 50 vol % based on the fluoropolymer. In these quantities the properties otherwise typical of ceramic, in particular the brittleness, do not yet take effect and adversely affect the properties of the carrier material.

The porous material used can further be fluoropolymers, in particular PTFE copolymers or blends as composites with thermoplastics. These thermoplastics are present in a quantity of 20 to 90 wt %, preferably 30 to 70 wt %, based on the fluoropolymer.

According to the invention the porous material has a porosity of more than 50%, preferably more than 60%, especially preferably more than 70%. Such high porosity of the porous material allows good penetration of the carrier material with the electrolyte and thus a high electrolyte content in the space between the electrodes. Furthermore, high porosity minimizes the volume fraction between the electrodes which is filled by the porous material and does not take part in ion flow. The high porosity of the material also has a positive effect on the active surface of the electrodes or the energy density and capacity of the energy storage device. With high porosity the contact surface between the carrier material and the electrode or the redox system is minimal so that the surface of the electrodes available for the storage process is not reduced unnecessarily.

Porous materials to be used are, e.g., fluoropolymers, polyethylenes, polypropylenes, PVC, nylon, glass fibers etc.

The formation of the porous structure is not limited to any certain technology. Pore-forming methods can include stretching, extracting a second component, dissolving out a component, applying the nuclear trace technique and pore formation by bubble formation. U.S. Pat. No. 3,953,566 describes e.g. the production of expanded porous PTFE.

The porosity of the porous material used according to the invention is calculated by the following equation:

Porosity=(1−rₘ/rₜ)×100%

where rₘ is the measured density of the material and rₜ the theoretical density thereof.

Porous fluoropolymers which can be used in an inventive energy storage device are e.g. PTFE and PTFE copolymers. The PTFE can e.g. also be a type of PTFE with comonomers, referred to as “modified PTFE”. This designation also covers polymers in which the homopolymer is modified by copolymerization with ethylically unsaturated comonomers, their share being <2 mass percent based on the copolymer. Examples of such comonomers are: ethylene, propylene, halogenated olefins such as hexafluoropropene, vinylidene fluorides and chlorotrifluoroethylene; cyclic fluorinated monomers or perfluoroalkylvinylethers such as perfluoropropylvinylethers, perfluoromethylvinylethers or perfluorovinylethers with terminal carboxyl or sulfonic acid groups.

If the share of copolymer is more than 2 mass percent, the porous fluoropolymers are called fluorothermoplastics, fluoroionomers or fluoroelastomers.

The starting material can also consist of fluorohomopolymers. Fluorohomopolymers can be present as blends with low-molecular PTFE. The fluorohomopolymers are likewise mixable with tetrafluoroethylene (TFE) copolymers processed from the melt, such as hexafluoropropylene/tetrafluoroethylene copolymers (FEP), perfluoroalkylvinyl/tetrafluoroethylene copolymers (PFA) or perfluorodioxol copolymers, e.g. available under the brand name Teflon AF from DuPont.

Porous fluoropolymers which can furthermore be used are polymers additionally having nano-scale ceramic. This is preferably added to the polymer in powder form.

Nano-scale ceramic powders in the sense of the invention include the group of metal oxides such as aluminum oxide, zirconium dioxide, silicon dioxide, titanium dioxide, zinc oxide and iron oxide as well as metal oxides with coatings (oxides, organic substances), mixed oxides, ferrites, metallic salts such as sulfates, sulfites, sulfides and phosphates. Naturally occurring materials, such as clays, kaolins, etc., can also be used.

The particle size of the nano-scale ceramic powders is preferably 2 to 300 nm.

The porous fluoropolymer is preferably present in the form of a membrane. The microstructure of the porous fluoropolymer can consist of knots and fibrils, only of fibrils, of fibril strands or bundles of fibrils or else of stretched knots interconnected by fibrils.

The fluoropolymer membrane is preferably present as a uni- or biaxially stretched polytetrafluoroethylene membrane. The preferred pore size of the fluoropolymer is in the range of 0.01 to 15 microns. The thickness of the porous fluoropolymer membrane is preferably between 1 to 1000 microns, preferably between 10 and 500 microns.

It is also within the scope of the invention to give the porous carrier material a multilayer design. One can use a sandwich of a porous fluoropolymer membrane with an ion-conductive membrane or a system comprising a porous fluoropolymer membrane, a conventional ion-conductive membrane and a further porous fluoropolymer membrane. The conventional ion-conductive membrane can be e.g. a filled plastic membrane, the membrane being filled e.g. with perfluorinated ionomers, e.g. from a copolymer of tetrafluoroethylene and perfluorovinylether with terminal sulfonic acid groups, or e.g. with doped ZrO₂. The use of such a system or sandwich additionally improves the ion flow in such a conventional membrane between the electrodes. Symmetrical or asymmetrical membranes can be used.

The presence of a perfluorinated polyether phosphate in the inner pore structure of the porous fluoropolymer makes the latter wettable and receptive for the electrolyte. This wettability ensures a sufficient hold of the electrolyte in the carrier material, in particular in the pores. A sufficient presence of electrolyte in the pores permits the ions to penetrate through the electrolyte-filled pores of the carrier material and thus high ion flow and high ion mobility, leading to low ohmic resistance of the storage device. Preferred microporous coated membranes have an electrical resistance below 50 milliohm/cm², most preferred below 20 milliohm/ cm².

Perfluoropolyethers are very stable under very harsh environments. They start decomposition at temperatures of 300 C. Until 150 to 160 C.; the weight loss is negligible. These perfluoropolyether are not soluble in water. Based on the fluorocarbon backbone structure, non polar perfluoropolyether are very compatible with ePTFE membranes and can be used as extremely thin surface coating to improve oleophobicity and contamination resistance.

Chemical and thermal stability of the modified porous material and stable adhesion of the substance to the porous material ensure a long life of the inventive storage device. It has been also found that the high porosity of the coated separator provides an advantage at the interphase of separator and cathode. The cathode is fully saturated with the electrolyte featuring a high active surface area.

In a preferred embodiment the inner pore structure of the porous material is coated at least partly with the perfluorinated polyether phosphate. Since the presence of the surface-active substance is realized in the form of a layer, excellent ion flow can be maintained in the electrolyte by the pore structure, as compared to pores being filled with a material. In addition, providing a layer on the inner surface of the pore structure does not significantly reduce the receiving capacity of the carrier material for an electrolyte.

The perfluorinated polyether phosphate has bifunctional phosphate terminal groups that provide the advantages of

Having a flexible perfluoropolyether backbone that is compatible with the ePTFE membrane;

Being supplied as oligomeric fluorocompound that is not soluble in water;

Having terminal phosphate endgroups directed to the surface;

Having a reservoir of endgroups at a fluorpolymer surface bridged by hydrogen bonding, resulting in an improved electrolyte wettability; and

Providing functional endgroups on a fluorinated polymer without persistent straight fluoroalkyl chain.

The perfluorinated polyether phosphate can be applied to or incorporated in the porous material by rolls, a dipping bath, spray technology and further known methods. Perfluorinated polyether phosphate can also be present in the electrolyte and washed into the porous material therewith. Due to the low surface tension of the perfluorinated polyether phosphate, a monolayer of the compound can already suffice. This has the advantage that even extremely small-pore fluoropolymer membranes can be sufficiently hydrophiled without the pore structure being sealed. After treatment with the perfluorinated polyether phosphate the porous fluoropolymer is preferably coated at least partly on the inner surface. However it is also within the scope of the invention to produce by the treatment an at least partial coating on both the inner and outer surfaces. The inner and outer surfaces of the porous fluoropolymer are preferably covered completely with the perfluorinated polyether phosphate. Initial porosity of the fluoropolymer and mean pore size are basically maintained.

In an alternative embodiment, a salt of the perfluorinated polyether phosphate is used.

The perfluorinated part of the molecule can, depending on the production method, be a) unbranched polyether; b) branched polyether; c) mixture of A and B; or d) highly branched. Perfluorpolyether can be crosslinked after coating to enhance durability. UV crosslinking as well as reaction with perfluoropolyether silanes can be used. A chain length of the perfluorinated molecule part of ten more carbon atoms is generally preferred.

The preferred perfluoropolyether is F10 made by Ausimont. It is known to be a mixture of the following two compounds:

F10 Phosphate

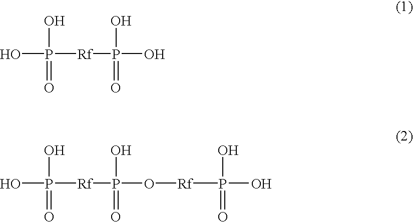

Rf=—(OCH₂CH₂)ₚOCH₂CF₂—O—(CF₂CF₂O)ₘ—(CF₂O)ₙ—CF₂CH₂O—(CH₂CH₂O)ₚ—

These perfluorinated polyether phosphates have high thermal and chemical stability which allows them to be used in aggressive media such as strong acids or bases, oxidizing or reducing solutions or at high temperatures. The nature of the polar molecule group of the surfactants furthermore influences the surface-active properties of the fluorosurfactant. Oligomeric perfluoropolyethers are generally preferred in the sense of the present invention which reduce the surface tension of the electrolytic solution to values of <28 mN/m. This presupposes a certain solubility of fluorosurfactant in the electrolyte.

Specifically with reference to F10, it is surprising that this material functions as a wetting agent for KOH. The product literature available for F10, such as “FLUOROLINK® Surface Treating Agents” (released April 2000), promotes its use as a barrier coating material to provide surface properties such as oil/water repellency. It is thus unexpected that it actually facilitates penetration of the KOH into the ePTFE.

The fluorinated polyether phosphate is preferably mixed with a solvent before being applied to the porous material. Water is preferred as a solvent according to the invention. However based on the solubility, other solvents might be used in combination with water such as alcohols alone or in combination with KOH or ammonia.

The solvent is removed after treatment of the porous material e.g. by guiding the carrier material over heated rollers or by means of forced-air ovens.

Most preferred coating procedure is solvent free. At elevated temperature the viscosity and surface tension of perfluoropolyether with phosphate endgroup allows easy wicking of that materials into ePTFE membranes.

Treatment of the porous material with a perfluorinated polyether phosphate results in a permanent modification with minimal application of the perfluorinated polyether phosphate. The latter is preferably applied to the porous material in monolayers or in limited fashion in multilayers. Especially permanent hydrophilic effects can be achieved depending on the selected modification variant. The perfluorinated polyether phosphate is held on the porous material by physical or electrostatic adsorption. This ensures excellent adhesion of the perfluorinated polyether phosphate to the porous material, thereby e.g. preventing the substance from being washed out and thus ensuring long life of the storage device. Preferred lay down of the perfluoropolyether at microporous membranes is between 0.5 and 20 g/m², most preferred between 1.0 and 10 g/m².

The perfluorinated polyether phosphate covers the total surface of the porous material. The thus treated porous material contains enough free and readily accessible reactive groups which are in a position to make the porous material wettable with an electrolyte. Furthermore a sufficient solubility of the perfluorinated polyether phosphate in the electrolyte is given in some application so that the surface tension of the electrolyte can be sufficiently reduced. The result of modification of the porous material is a changed more hydrophilic surface with an increased share of ionogenic groups in comparison to the starting material. The coating is therefore done using an excess of perfluorinated polyether phosphate, part of the functional groups being used to manifest the hydrophilic property and the rest serving to reduce the surface tension of the electrolyte, if necessary.

In a further embodiment the perfluoropolyether phosphate is present partly in the electrolyte. Perfluorinated polyether phosphate has sufficient solubility in some electrolytes that it not only promotes hydrophiling of the surface of the carrier material but additionally reduces surface tension in the electrolyte. This reduced surface tension contributes considerably to sufficient wetting of the carrier material and electrode, if necessary. Additionally the presence of perfluorinated polyether phosphate in the electrolyte improves the ionic conductivity of the electrolyte and durability of the device.

The electrochemical energy storage device according to the present invention is preferably a capacitor. Ionic conductivity of the electrolyte and good wetting of the electrodes are very important in particular with capacitors. The advantages of the invention are therefore optimally exploited in a capacitor, in particular an electrolytic capacitor. The most preferred application are batteries like nickel/cadmium high rate, nickel metal hybrid, rechargeable MnO₂, Zn—MnO₂, Zn/Air, alkaline capacitors and alkaline fuel cells. The environments in these devices are typically very aggressive and destroy conventional carrier materials over time. Use of the perfluorinated polyether phosphate enhances the durability of the device because it is more resistant to the reactive agents in such aggressive environments.

If the inventive electrochemical energy storage device is a capacitor, it consists of electrodes and a carrier material penetrated by the electrolyte. When voltage is applied to the electrodes an ion flow is caused in the electrolyte. The capacitance of such a capacitor is dependent on the active surface of the electrodes and inversely proportional to the thickness of the electrochemical double layer, comprising the ionic electrolyte components in the carrier material, formed on the contact surface between electrolyte and electrode.

The active surface of the electrodes is determined by the contact surface between electrode and electrolyte. To increase the specific surface area, the electrode can have a certain roughness or porosity which can extend into the nanometer range. The thus enlarged surface is to enter into contact with the electrolyte as far as possible. Dead places, e.g. due to air pockets or due to the contact of the carrier material with the electrode, are thus to be kept as small as possible. In the inventive energy storage device, the surface to be activated is optimized by using a porous material with high porosity and a surface modified by a perfluorinated polyether phosphate as a carrier material. The high porosity minimizes the contact surface between the carrier material and the electrodes, and the reduced surface tension of the electrolyte ensures sufficient wetting of the electrode. The available surface can thus be optimally exploited.

The use of a porous fluoropolymer which has been treated with a perfluorinated polyether phosphate thus has the following advantages for a capacitor:

the carrier material serves as a reliable spacer between the electrodes;

electrolytic flow is optimized due to the high porosity and good wettability of the carrier material;

the ultra-thin perfluoropolyether layer positively influences the ion flow and ion mobility in the electrolyte;

the carrier material has outstanding temperature resistance and chemical stability lending durability to the device; and

the pore size of the carrier material can be adapted to prevent dendrite formation or to limit electrical shorts.

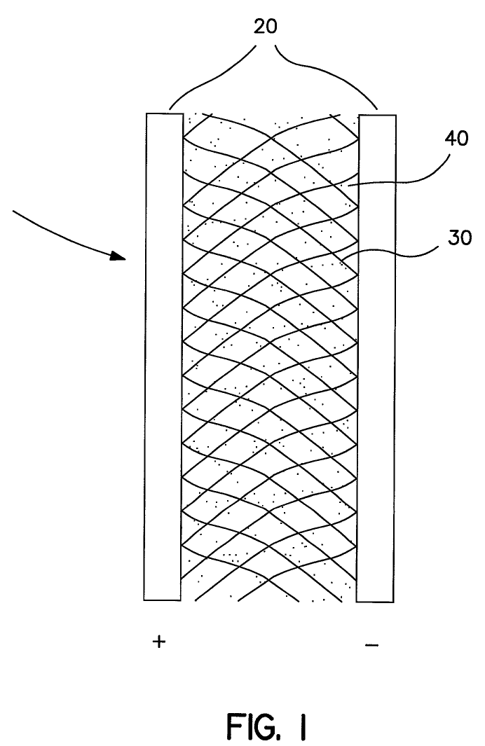

FIG. 1 shows schematically the structure of an embodiment of a capacitor according to the present invention and will be described in the following.

Storage device 10 has two electrodes 20, e.g. of titanium, which can be subjected to voltage by connections not shown in the figure. Between the electrodes there is carrier element 130, e.g. expanded porous PTFE, coated with a perfluorinated polyether phosphate, which is penetrated by electrolyte 40, e.g. KOH, and holds it in its pores.

The electrolyte used can be an aqueous salt solution, aqueous solution of inorganic or organic acids and bases. One can also use gels e.g. from acids or bases in combination with inorganic oxides or salts such as aluminum oxide, zirconium dioxide, silicon dioxide, titanium dioxide, zinc oxide and iron oxide as well as metal oxides with coatings (oxides, organic substances), mixed oxides, ferrites, metallic salts such as sulfates, sulfites, sulfides and phosphates. One can also use polyfunctional organic compounds such as ionomers, polyelectrolytes or polyelectrolyte complexes. Preferred electrolytes are aqueous solution of potassium hydroxide (KOH). Most preferred electrolytes are KOH solution between 15 and 40% by weight.

The redox systems used in the inventive energy storage device can be e.g. redox systems of ruthenium, manganese or chromium.

The electrodes of the inventive energy storage device can be present in the form of plates or foils. It is also within the scope of the invention, however, to design the electrodes in other forms, such as stick electrodes.

The invention will be explained more closely in the following with reference to examples. The physical quantities were determined as follows.

### TEST METHODS

Porosity

This was calculated by the following equation:

Porosity=(1−rₘ/rₜ)×100%

where rₘ is the measured density of the material and rₜ the theoretical density thereof.

Mean pore size (Mean flow pore size, MFP)

A piece of membrane with a 25 mm diameter was wetted with a perfluoropolyether (Porofil). The wetted membrane was placed in a Coulter porometer II (Coulter Electronics Ltd.) and the mean pore size ascertained.

Surface tension

Surface tension was measured with the processor tensiometer K12 from KRÜSS-GmbH Hamburg using Wilhelmy's plate method. A plate of exactly known geometry was brought in contact with the liquid. The force with which the liquid moves along the wetting line on the plate was measured. This force is directly proportional to surface tension of the liquid.

Conductivity

Conductivity measurements of solutions were performed on the microprocessor precision conductometer LF 539 from Wissenschaftlich-Technische Werkstatten GmbH. The standard conductivity measuring cell TetraCon 96 was used.

Gurley (air permeability)

The Gurley air flow test measures the time in seconds for 100 cm³ air to flow through an one square inch sample (6,45 cm²) at 12.4 mm of water pressure, the sample is measured in a Gurley Densometer (ASTM 0726-58).

Electrical resistance (Palico bath):

The measurements were done at room temperature using the Palico 9100-2 system. A four -terminal “Kelvin” measurement method was performed to improve accuracy by extracting data without regard to the quality of the connection the test electrodes make in the electrolyte. 32% KOH was used as electrolyte.

### EXAMPLES

### Example 1

A 40 micrometer thick membrane of expanded polytetrafluoroethylene (porosity 80%, GORE-TEX® membrane, obtained from W. L. GORE & Associates GmbH) was coated via a roll coater with a perfluoropolyether with phosphate terminal groups (Fluorolink® a F10 made by Ausimont). The rolls and F10 were heated up to 45 C. The coated membrane was guided through a heated furnace (160° C.). After coating and heat treatment, one obtained a membrane with a perfluoropolyether lay down of 4 g/m². The Gurley number was slightly changed from 15 s to 19-20 s. 35% KOH solution in water wetted the membrane. Membrane resistance was measured, using a PALICO bath, and was 15 milliohm cm². (See Table 1.)

### Example 2

A 35 micrometer thick membrane of expanded polytetrafluoroethylene (porosity 80%, GORE-TEX® membrane, obtained from W. L. GORE & Associates GmbH) was coated via a roll coater with a F10 perfluoropolyether solution in methanol (Fluorolink® F10 made by Ausimont, 3.0% solution). The membrane was dipped into F10 solution at ambient temperature. The coated membrane was guided through a heated solvent furnace (130° C.). After coating, solvent removal and a second heat treatment at 160 C., one obtained a membrane with a perfluoropolyether lay down of 2.5 to 3 g/m². 30% KOH solution in water wetted the coated membrane instantly within 1 second. Resistance was measured and is reported in Table 1 below.

### Example 3

A 45 micrometer thick membrane of expanded polytetrafluoroethylene (GORE-TEX® membrane, obtained from W. L. GORE & Associates GmbH, WO 9706206) was coated via a roll coater with a F10 perfluoropolyether solution in methanol (Fluorolink® F10 made by Ausimont, 5.0 % solution). The membrane was dipped into F10 solution at ambient temperature. The coated membrane was guided through a heated solvent furnace (130° C.). After coating and solvent removal, one obtained a membrane with a perfluoropolyether lay down of 3 to 4 g/m² and a thickness of 40 micrometer. 30% KOH solution in water wetted the coated membrane instantly within 1 second Membrane resistance was measured, using a PALICO bath, and was 6-12 milliohm cm². (See Table 1.)

TABLE 1

| | Celgard | | | |
|---|---|---|---|---|
| | 3500 * | Example 1 | Example 2 | Example 3 |
| Gurley s | 350-401 | 19-20 | 8-9 | 16-17 |
| Thickness μm | 25 | 25-29 | 25-27 | 40 |
| Electrical resistance | 19 | 15** | 16** | 4-12** |
| (30% KOH) | | | | |
| milliohm cm² | | | | |
| Lay down % (add on) | 18 | 19 | 15 | 12 |
| Wet out 30% KOH | <30 s | Within 1 s | Within 1 s | Within 1 s |

*Celgard Product Information March 1994 (except for Gurley number)
**32% KOH

The inventive energy storage device is preferably a double-layer capacitor. The carrier material also receives the electrolyte and holds it well with this capacitor. The most preferred application are batteries like nickel/cadmium high rate, nickel metal hybrid, rechargeable MnO₂, Zn—MnO₂, Zn/Air, alkaline capacitors and alkaline fuel cells.

Due to the perfluoropolyether and/or fluorinated substance the electrodes and membranes are wetted well with the electrolyte and the total available surface activated. All of the properties above for Examples 1-3 indicate a range of performance variables that is superior to a conventional material Celgard 3500. Specifically, the invention of Examples 1-3 shows higher porosity at comparable and greater thickness, with lower electrical resistance, at comparable or lower amounts of lay down, and wets out much faster.

Finally the inventive storage device can also advantageously be a battery.

In the widest sense the inventive carrier material can be used as an electrolytic storage device, separator or diaphragm in particular in electrochemical systems such as electrolysis or electrodialysis applications.

Although a few exemplary embodiments of the present invention have been described in detail above, those skilled in the art readily appreciate that many modifications are possible without materially departing from the novel teachings and advantages which are described herein. Accordingly, all such modifications are intended to be included within the scope of the present invention, as defined in the following claims.

1. An electrochemical energy storage device comprising at least two electrodes and an electrolyte, and a carrier material for the electrolyte being disposed between said electrodes, wherein said carrier material comprises a porous material having an inner pore structure in which a perfluorinated polyether phosphate is present.

2. The electrochemical energy storage device of claim 1, wherein the porous material is a porous fluoropolymer.

3. The electrochemical energy storage device of claim 1, wherein the inner pore structure of the porous material is coated at least partly with said perfluorinated polyether phosphate.

4. The electrochemical energy storage device of claim 1, wherein said electrolyte is KOH.

5. The electrochemical energy storage device of claim 1, wherein the porous material is expanded polytetrafluoroethylene.

6. The electrochemical energy storage device of claim 1, wherein the porous material is a PTFE copolymer.

7. The electrochemical energy storage device of claim 1, wherein the carrier material is a composite containing nano-scale ceramic.

8. The electrochemical energy storage device of claim 1, wherein the carrier material is a composite including thermoplastics.

9. The electrochemical energy storage device of claim 1, wherein the porous material has a porosity of more than 50%.

10. The electrochemical energy storage device of claim 1, wherein the porous material has a porosity of more than 70%.

11. The electrochemical energy storage device of claim 1, wherein said electrochemical energy storage device is a capacitor.

12. The electrochemical energy storage device of claim 1, wherein said electrochemical energy storage device is a battery selected from the group consisting of nickel/cadmium high rate, nickel metal hybrid, rechargeable MnO₂, Zn—MnO₂, Zn/Air, alkaline capacitors and alkaline fuel cells.

13. The electrochemical energy storage device of claim 1, wherein said electrochemical energy storage device is an alkaline capacitor.

14. The electrochemical energy storage device of claim 1, wherein said electrochemical energy storage device is an alkaline fuel cell.
